(19) United States
(12) Patent Application Publication
(10) Pub. No.: US 2010/0239245 A1
(43) Pub. Date: Sep. 23, 2010

(54) Polarization Mode Emulators and Polarization Mode Dispersion Compensators Based on Optical Polarization Rotators with Discrete Polarization States

(75) Inventor: Xiaotian Steve Yao, Diamond Bar, CA (US)

Correspondence Address: FISH & RICHARDSON, PC, P.O. BOX 1022, MINNEAPOLIS, MN, 55440-1022, US

(73) Assignee: GENERAL PHOTONICS CORPORATION, Chino, CA (US)

(21) Appl. No.: 12/728,938

(22) Filed: Mar. 22, 2010

Related U.S. Application Data
(60) Provisional application No. 61/162,289, filed on Mar. 21, 2009.

(51) Int. Cl. H04B 10/08; G02B 5/30; G01J 4/00; H04J 14/06

(52) U.S. Cl. 398/27; 359/497; 356/365; 398/65; 398/29

(57) ABSTRACT

Systems, devices and techniques for generating and analyzing states of polarization in light using multiple adjustable polarization rotators having different discrete polarization rotation states in various applications.

### PRIORITY CLAIM

This patent document claims priority of U.S. Provisional Application No. 61/162,289 entitled “POLARIZATION MODE EMULATORS AND POLARIZATION MODE DISPERSION COMPENSATORS BASED ON TRI-STATE OPTICAL POLARIZATION ROTATORS” and filed Mar. 21, 2009, which is incorporated by reference as part of the disclosure of this document.

### BACKGROUND

This patent document relates to optical polarization devices and their applications, including polarization mode emulators and polarization mode dispersion compensators.

Optical properties or parameters of light in an optical device or system may be measured for various purposes. As an example, such an optical measurement may be used to determine the performance or an operating condition of the device or system. Optical polarization, for example, is an important parameter of an optical signal in various optical systems, devices and applications. Optical polarization, the optical signal to noise ratio (OSNR), the differential group delay (DGD) between two orthogonal polarization states, for example, are optical parameters that are important to various optical applications. In fiber optic communication systems, polarization-mode dispersion (PMD), can significantly impact the performance and proper operations of optical devices or systems, especially as the bit rate of fiber optic communication systems increases (e.g., from 10 Gbps to 40 Gbps, 100 Gbps, and beyond). PMD generally causes two principle polarization components of a light signal to travel at different speeds and hence spreads the bit-width of the signal. Consequently, it causes the increase in the bit-error rate (BER) and service outage. Unlike other system impairments, such as chromatic dispersion (CD), PMD effect on the system is random in nature and changes rapidly with time, making it difficult to mitigate.

### SUMMARY

This document includes implementations of systems, devices and techniques for generating and analyzing states of polarization in light using multiple adjustable polarization rotators having different discrete polarization rotation states in various applications.

In one aspect, an optical device is provided to include an input port to receive input light, differential group delay (DGD) segments and tunable optical polarization rotators respectively located in gaps between the DGD segments. Each DGD segment exhibits optical birefringence to effectuate a DGD between light of two orthogonal polarizations pass through the DGD segment and the DGG segments are arranged separated from one another along an optical path that receives the input light from the input port. Each tunable optical polarization rotator is operable rotates polarization of light after exiting one DGD segment and before entering a downstream DGD segment and the tunable optical polarization rotators include at least one continuously tunable optical rotator responsive to a continuous tuning control signal to continuously rotate polarization of light to reach a desired rotation of the polarization of light, and discrete-state tunable optical polarization rotators responsive to respective discrete-state control signals to produce two or more different discrete polarization rotations. This device includes a control module in communication with the tunable optical polarization rotators to individually control each of the optical polarization rotators. The control module is operable to produce varying values of the continuous tuning control signal in operating the continuously tunable optical rotator, and to produce one of discrete values of each discrete-state control signal to operate each respective discrete-state tunable optical polarization rotator to produce a respective one of the two or more discrete polarization rotations. The discrete-state tunable optical polarization rotators can be tunable two-state polarization rotators each adjustable to change a rotation of polarization of light transmitting therethrough between a first rotation angle and a second equal rotation angle in an opposite direction of the first rotation angle.

In another aspect, an optical device is provided to include differential group delay (DGD) segments each exhibiting optical birefringence to effectuate a DGD between light of two orthogonal polarizations that transmits through each DGD segment, the DGG segments arranged along an optical path and separated from each other along the optical path; tunable optical polarization rotators respectively located in gaps between the DGD segments, one tunable optical polarization rotator per gap to rotate polarization of light after exiting one DGD segment and before entering a downstream DGD segment, each tunable optical polarization rotator responsive to a control signal to produce three different polarization rotations; and a control module in communication with the tunable optical polarization rotators to individually control each of the optical polarization rotators to produce one of the three different polarization rotations to produce polarization mode dispersion of a first order and one or more higher orders on the light that transmits through the DGD segments and the tunable optical polarization rotators.

In another aspect, a communication device for optical wavelength division multiplexing (WDM) is provided to include a WDM demultiplexer that separates optical WDM signals at different WDM wavelengths along different signal paths; and optical receivers located in the different signal paths, respectively, each optical receiver receiving one optical WDM signal at a respective WDM wavelength to extract data carried by the received optical WDM signal. Each optical receiver includes a polarization mode dispersion (PMD) compensator that includes differential group delay (DGD) segments each exhibiting optical birefringence to effectuate a DGD between light of two orthogonal polarizations that transmits through each DGD segment, the DGG segments arranged along an optical path and separated from each other along the optical path; tunable optical polarization rotators respectively located in gaps between the DGD segments, one tunable optical polarization rotator per gap to rotate polarization of light after exiting one DGD segment and before entering a downstream DGD segment, each tunable optical polarization rotator responsive to a control signal to produce three different polarization rotations; and a control module in communication with the tunable optical polarization rotators to individually control each of the optical polarization rotators to produce one of the three different polarization rotations to produce polarization mode dispersion of a first order and one or more higher orders on the light that transmits through the DGD segments and the tunable optical polarization rotators to negate PMD in the received optical WDM signal.

In yet another aspect, a method for measuring optical polarization mode dispersion (PMD) in a fiber link is provided to include using a WDM demultiplexer to receive optical wavelength-division-multiplexed (WDM) signals at different WDM wavelengths from a fiber link and to separate the received optical WDM signals along different signal paths; splitting light received at the WDM demultiplexer at a location upstream from the WDM demultiplexer to produce an optical monitor signal to an optical monitor signal path separate from the different signal paths; tuning an tunable optical filter in the optical monitor signal path to a selected WDM channel to filter light of the optical monitor signal to transmit light within the selected WDM channel as a filtered optical monitor signal for the selected WDM channel; and using a PMD instrument to process the filtered optical monitor signal for the selected WDM channel to measure PMD of the selected WDM by using differential group delay (DGD) segments separated from each other along the optical path and each exhibiting optical birefringence to effectuate a DGD between light of two orthogonal polarizations that transmits through each DGD segment, and by using tunable optical polarization rotators respectively located in gaps between the DGD segments. The tunable optical polarization rotators include discrete-state tunable optical polarization rotators responsive to respective discrete-state control signals to produce two or more different discrete polarization rotations. This method includes individually controlling each of the tunable optical polarization rotators to produce polarization mode dispersion of a first order and one or more higher orders on the light that transmits through the DGD segments and the tunable optical polarization rotators to negate PMD in the selected WDM channel; and using settings of the tunable optical polarization rotators and DGD values of the DGD segments to measure the PMD in the fiber link for the selected WDM channel.

These and other aspects are described in detail in the drawings, the description and the claims.

### BRIEF DESCRIPTION OF THE DRAWINGS

FIG. 1 shows an exemplary optical device that can be used for PMD compensation or PMD emulation based on polarization rotators with three discrete polarization states and birefringent materials with different differential group delays.

FIG. 2 shows an exemplary implementation of the tri-state polarization rotators in FIG. 1.

FIG. 3 shows an exemplary optical device that can be used for PMD compensation or PMD emulation based on polarization rotators with two discrete polarization states and birefringent materials with different differential group delays.

FIG. 4 shows an exemplary optical device that can be used for PMD compensation or PMD emulation based on mixed polarization rotators with two and three discrete polarization states and DGD segments with different differential group delays.

FIG. 5 shows an exemplary optical device that can be used for PMD compensation or PMD emulation having at least one continuously tunable polarization rotator, polarization rotators with discrete polarization states and DGD segments with different differential group delays.

FIG. 6 shows second order PMD values as a function of the DGD values for an optical device based on the device in FIG. 5 having polarization rotators with three discrete polarization states and DGD segments with different differential group delays.

FIGS. 7A and 7B show second order PMD values as a function of the DGD values for an optical device based on the device in FIG. 5 having a continuously tunable polarization rotator, polarization rotators with two discrete polarization states and DGD segments with different differential group delays.

FIG. 8 shows an example of a polarization optimized PMD source or emulator based on the devices in FIGS. 1-5.

FIG. 9A shows a device for performing PMD tolerance tests that measure the tolerance to PMD of a fiber communication channel.

FIGS. 9B and 9C show bit error rate (BER) data with respect to DGD values and PMD values, respectively, in connection with the device in FIG. 9A.

FIG. 10 shows an example of a wavelength-division-multiplexed (WDM) system that uses the devices in FIGS. 1-5 for link PMD estimation or determination.

FIGS. 11A and 11B show two optical WDM communication systems that provide PMD compensation in feedback loops based on the devices in FIGS. 1-5.

FIGS. 12 and 13 show two exemplary optical communication systems equipped with PMD monitoring and PMD compensation.

### DETAILED DESCRIPTION

This document discloses optical PMD compensators and PMD emulators using polarization rotators with discrete polarization states, such as bi-state polarization rotators, tri-state polarization rotators, combinations of bi-state polarization rotators and tri-state polarization rotators, and optical PMD compensators and PMD emulators using polarization rotators with discrete polarization states and at least one continuously tunable polarization rotators. A polarization rotator with discrete polarization states can be controlled to produce two or more different, discrete rotations on light in response to different values in a control signal applied to the polarization rotator. A tri-state polarization rotator, for example, can be controlled to produce three different rotations on light in response to three different values in a control signal. In the PMD compensators and emulators described in this document, the polarization rotators with discrete polarization states such as bi-state or tri-state polarization rotators are used in combination with multiple birefringent segments of different DGD values to produce not only the first order PMD but also one or more higher orders in PMD, e.g., the second order PMD. Therefore, the described PMD compensators and emulators can be used to provide effective PMD compensation and emulation.

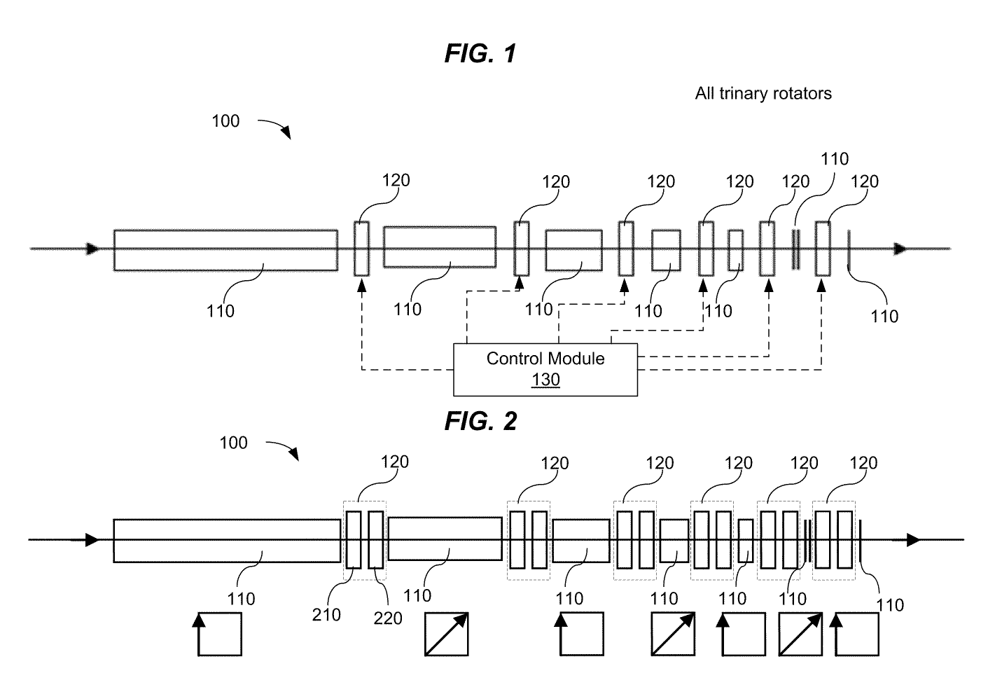

FIG. 1 shows an optical device 100 that can be used for PMD compensation or PMD emulation based on tri-state polarization rotators. The device 100 includes multiple differential group delay (DGD) segments 110 and tunable optical polarization rotators 120. Each DGD segment 110 is formed from a birefringent material exhibiting optical birefringence to effectuate a DGD between light of two orthogonal polarizations that transmits through each DGD segment. The DGG segments 110 are arranged along an optical path and separated from each other along the optical path. The tunable optical polarization rotators 120 are respectively located in gaps between the DGD segments 110, one tunable optical polarization rotator 120 per gap to rotate polarization of light after exiting one DGD segment 110 and before entering a downstream DGD segment 110. Each tunable optical polarization rotator 120 is responsive to a control signal to produce three different polarization rotations and thus is a tri-state polarization rotator. A control module 130 is connected to be in communication with the tunable optical polarization rotators 120 to individually control each of the optical polarization rotators 120 to produce one of the three different polarization rotations to produce polarization mode dispersion of a first order and one or more higher orders on the light that transmits through the DGD segments 110 and the tunable optical polarization rotators 120. This device 100 can be operated to control the produced PMD to negate PMD in the received optical wavelength-division-multiplexed (WDM) signal and hence is a PMD compensator. This device 100 can also be used to produce various PMD effects for PMD simulation.

The DGD segments 110 can have different lengths to produce different DGD values. As illustrated in FIG. 1, the DGD segments 110 made of the same birefringent material can have decreasing lengths along the optical path from the left to the right. The lengths of the DGD segments 110 can also increase from the left to the right along the optical path. In some implementations, the lengths of the DGD segments 110 can differ by a factor of 2 or 2^{m}, where m is an integer. The DGD segments 110 can be configured to produce fixed DGD values.

Alternatively, the DGD segments 110 can be tunable DGD segments each producing a variable DGD under a control signal. An electro-optic material, for example, can be included in such a tunable DGD segment to vary the DGD value by varying a respective control electrical voltage. Other techniques can also be used to produce controllable DGD segments 110. For example, fiber actuators can be coupled to a segments of polarization-maintaining fiber to squeeze polarization-maintaining fiber segments as the tunable DGD segments 110. As another example, each variable DGD segment 110 can be formed by cascading multiple birefringent segments of different lengths in an optical path, and using tunable optical rotators to couple adjacent birefringent segments. As the optical rotators are controlled to rotate the optical polarization of light, the DGD value of the light passing through the optical path changes. In some implementations, the above tunable optical rotators can be replaced by polarization switches that connect two adjacent birefringent segments to switch the polarization of received light between a first state where the slow and fast principal axes of the preceding birefringent segment are respectively aligned with the slow and fast principal axes of the succeeding birefringent segment, and a second state where the slow and fast principal axes of the preceding birefringent segment are respectively aligned with the fast and slow principal axes of the succeeding birefringent segment. When the polarization switch is set to the first state, the DGD values of the two connected adjacent birefringent segments are added; in the second state, the DGD values of the connected two adjacent birefringent segments are subtracted. In some implementations, tunable optical rotators and polarization switches can both be used to connect adjacent birefringent segments of a series of birefringent segments to form the variable DGD segment 110. Exemplary implementations of a variable DGD section 110 are described in U.S. Pat. No. 5,978,125 and U.S. Pat. No. 7,227,686, both to Yao, which are incorporated by reference as part of the disclosure of this document.

Tunable DGD segments 110 can be combined with the tunable optical polarization rotators 120 to provide additional technical flexibility in generating a desired DGD distribution to more effective PMD compensation or PMD emulation than using the fixed DGD segments. When the DGD segments 110 are tunable, the control module 130 can be used to control both the DGD segments 110 and the optical polarization rotators 120.

FIG. 2 shows an exemplary implementation of the tri-state polarization rotators 120 in FIG. 1. Each tunable optical polarization rotator 120 in this example includes two two-state polarization rotators 210 and 220 placed in series along the optical path. Each two-state rotator 210 or 220 is adjustable to change a rotation of polarization of light transmitting therethrough between a first rotation angle and a second equal rotation angle in an opposite direction of the first rotation angle. The two-state polarization rotators 210 and 220 are controlled collectively to produce the three different polarization rotations. The control module 130 can be used to operate the two two-state polarization rotators 210 and 220 in each optical polarization rotator 120 to both rotate polarization by the first rotation angle so that the total rotation of the polarization is twice the first rotation angle. This is the first of the three different rotations of the tri-state rotator 120. The control module 130 can also control the first two-state rotator 210 to rotate polarization by the first rotation angle and the second two-state rotator 220 to rotate the polarization by the second opposite rotation angle to produce a total rotation of the sum of the two rotation angles. Because the two rotation angles are in opposite directions, the net rotation is zero. This is the second of the three rotations by the tri-state rotator 120. When both two-state rotators 210 and 220 are controlled to rotate polarization by the second opposite rotation angle, the total rotation is twice the second rotation angle but is in an opposite rotation direction to the first rotation angle. This is the third state of the three different rotations of the tri-state rotator 120.

In some implementations, the two-state polarization rotators 210 and 220 can be magneto-optic (MO) polarization rotators to avoid any mechanical moving part. This use of MO rotators or other polarization rotators without moving parts can improve the reliability and operating life of the device. For example, the two-state MO rotator can be designed to have the following properties: (1) when a positive voltage above the saturation voltage Vsat of the MO rotator is applied to the MO rotator (i.e., V≧+Vsat), the MO rotator rotates the SOP of light by +22.5°; and (2) when a negative voltage above the saturation voltage Vsat is applied (i.e., V≦−Vsat), the rotator rotates the SOP by −22.5°. Alternatively, other types of polarization rotators such as liquid crystal polarization rotators and solid-state birefringent crystal polarization rotators may also be configured with the above operating states with appropriate control signals.

As a specific example, for each two-state polarization rotator, the first rotation angle can be +22.5°, and the second opposite rotation angle can be −22.5°. Each rotator pair can rotate the polarization of the incoming light in three different ways: a total rotation of +45 degrees by a rotation of +22.5 degrees via the rotator 210 and another rotation of +22.5 degrees via the rotator 220, a rotation of 0 degree by a rotation of +22.5 degrees via the first rotator 210 and a rotation of −22.5 degrees via the second rotator 220, and a total rotation of −45 degrees by a rotation of −22.5 degrees via both the first rotator 210 and the second rotator 220. A rotator pair is sandwiched between two adjacent birefringent materials or DGD segments to form a simple PMD source or generator. When the rotator pair between two adjacent crystals rotate the SOP by +45 degrees, the optical axes of the two crystals are aligned to produce the maximum combined DGD. When the rotator pair between two adjacent crystals rotate the SOP by −45 degrees, the optical axes of the two crystals are counter-aligned to produce the minimum combined DGD. When the rotator pair between two adjacent crystals rotate the SOP by 0 degree, the optical axes of the two crystals are 45 degrees from each other to produce the second order PMD. The 0-degree polarization rotation by each rotator pair allows the PMD compensators and emulators to produce higher order PMD effects.

The total number of PMD values can be generated with (N+1) sections of birefringent material and N rotator pairs is 3^{N}. For N=6, the total PMD values are 729. The total values of DGD (1st order PMD) is 2N. For N=6, the total DGD values are 64. Alternatively, N sections of birefringent material and N rotator pairs can be used to generate 3N PMD values, where the absolute DGD range is reduced by one half because the DGD values are from −DGDmax/2 to +DGDmax/2.

In FIG. 2, the two polarization rotators 210 and 220 in the pair for the tri-state rotator 120 can be activated at different times to minimize transient loss.

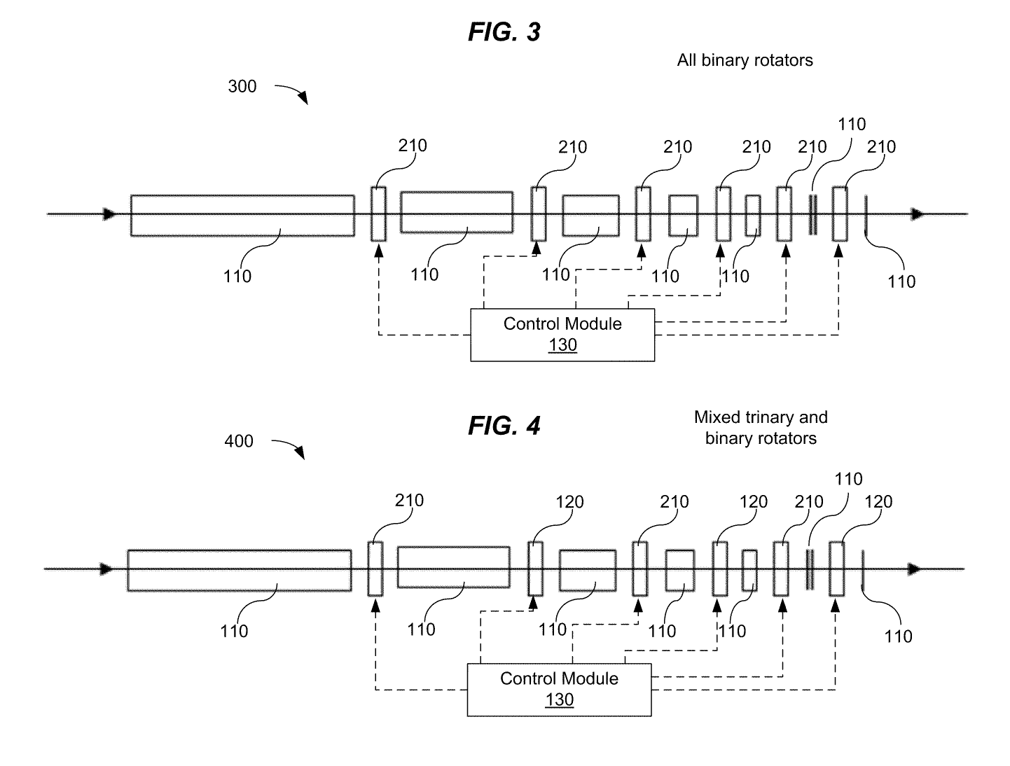

FIG. 3 shows an example of an optical device 100 that can be used for PMD compensation or PMD emulation based on two-state polarization rotators. The device 300 is similarly structured as the device 100 in FIG. 1 but replaces the tri-state polarization rotators 120 with two-state rotators, such as the rotators in FIG. 2. The total number of PMD values can be generated with (N+1) sections of birefringent material and N rotator pairs is 2^{N}, which is less than the number of PMD values generated by the device in FIG. 1 having the same number of birefringent segments 110. The use of two-state rotators in FIG. 3 is less expensive than the tri-state polarization rotators 120 by using one half of the two-state polarization rotators required in the system in FIG. 2.

FIG. 4 shows an exemplary optical device that can be used for PMD compensation or PMD emulation based on mixed polarization rotators with two and three discrete polarization states and birefringent materials with different differential group delays. The numbers of polarization rotators 210 with two discrete polarization states and polarization rotators 120 with three discrete polarization states and their relative positions in the device can be configured based on the specific requirements of a particular application.

The above configurations of optical devices for PMD compensation or PMD emulation based on discrete-state polarization rotators interleaved with DGG segments 110 provide programmable distinctive PMD values for various applications where PMD compensation or PMD emulation is provided. In some applications, in addition to distinctive PMD values, it may be desirable to provide some degree of continuous tuning in the PMD value from one discrete PMD value to another. Using one or more continuously tunable polarization rotators to replacing polarization rotators with discrete polarization states can provide some degree of continuous tuning in the PMD value and to increase the number of PMD values relative to a similar device using discrete-state polarization rotators.

Such a device with one or more continuously tunable polarization rotators can be configured to include DGD segments each exhibiting optical birefringence to effectuate a DGD between light of two orthogonal polarizations that transmits through each DGD segment, and tunable optical polarization rotators respectively located in gaps between the DGD segments each operable to rotate polarization of light after exiting one DGD segment and before entering a downstream DGD segment. The tunable optical polarization rotators include discrete-state optical polarization rotators and one or more continuously tunable optical polarization rotators. Each discrete-state optical polarization rotator is responsive to a respective control signal to produce two or more different discrete polarization rotations. Each continuously tunable polarization rotator is responsive to a respective control signal to continuously rotate the polarization of the lights as the control signal, e.g., a voltage, changes continuously within an operating range. A control module is provided to be in communication with the discrete-state optical polarization rotators to individually control each of the optical polarization rotators to produce one of the different, discrete polarization rotations. The control module is also in communication with the one or more continuously tunable optical polarization rotators to control each continuously tunable optical polarization rotator.

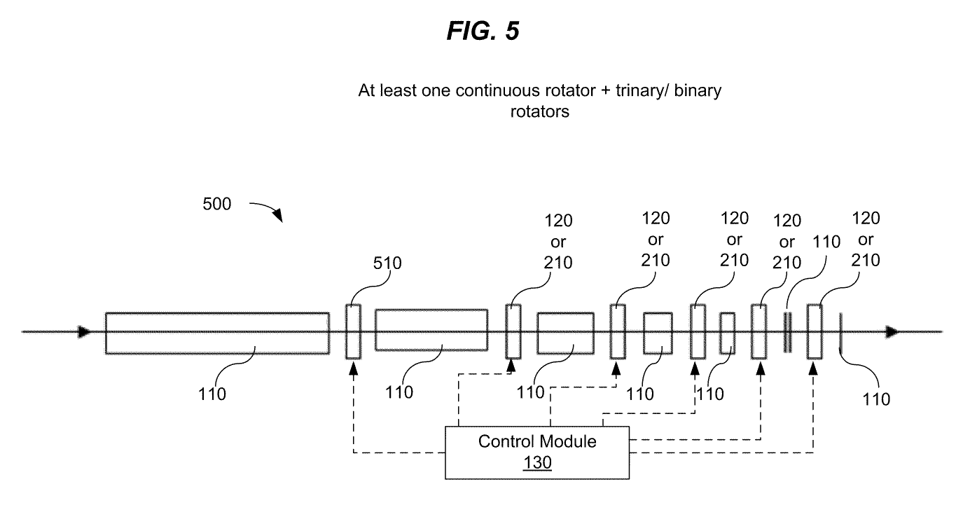

FIG. 5 shows an exemplary optical device 500 that can be used for PMD compensation or PMD emulation having one continuously tunable polarization rotator 510, discrete-state polarization rotators 120 or 210 and DGD segments with different differential group delays. In this example, the continuously tunable polarization rotator 510 is placed between the first and second DGD segments 110 at the beginning portion of the device and the discrete-state polarization rotators 120 or 210 are placed downstream from the continuously tunable polarization rotator 510. In other implementations, the continuously tunable polarization rotator 510 can be placed at other locations in the device.

Various studies were conducted on the PMD behavior of the devices in FIGS. 1-5. One of the aspects of the devices in FIGS. 1-5 is the dependence of the generated PMD values on the wavelength of the light. Some PMD values or states generated by the devices in FIGS. 1-5 are dependent on the optical wavelength while some are independent of the optical wavelength. The wavelength-dependent PMD values or states generated by the devices in FIGS. 1-5 can complicate PMD emulation or compensation and compromise the performance in WDM communication systems and other applications where light of different wavelengths is processed. It is desirable to operate a PMD emulation or compensation device at PMD values or states that are independent of the optical wavelength.

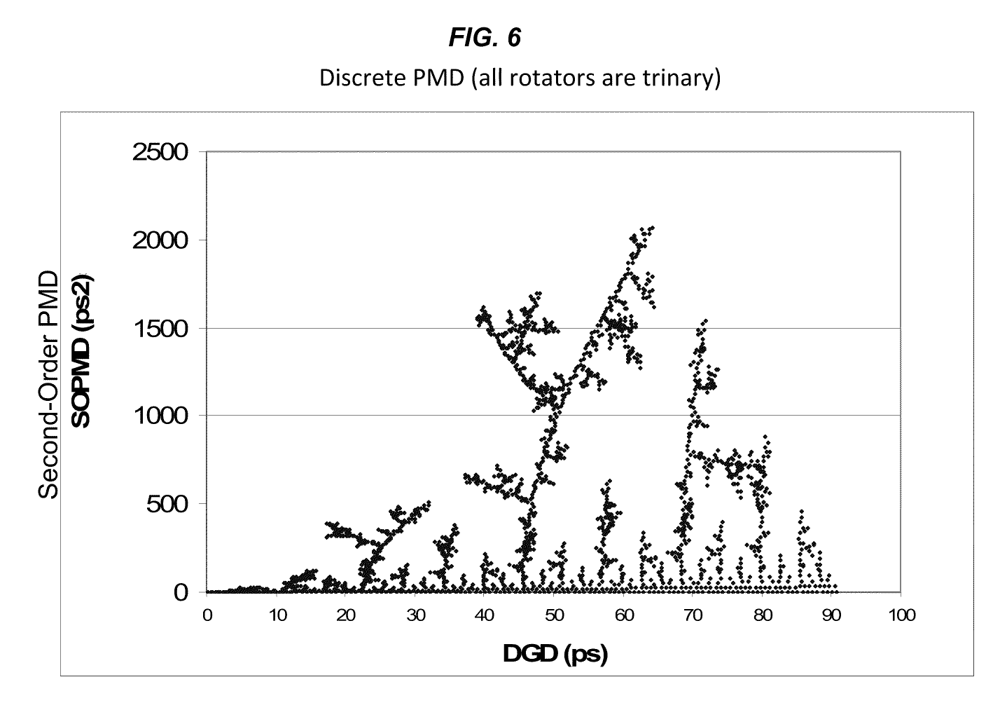

FIG. 6 shows the second-order PMD (SOPMD) values of one implementation of the device with all tri-state polarization rotators in FIG. 1 as a function of the DGD values generated by the device. The SOPMD values are distributed in various regions of the SOPMD-DGD map. This device lacks the continuous tuning of the SOPMD for various DGD values. It is also discovered that only some of the SOPMD values in this device are independent of the optical wavelength of light while other SOPMD values are dependent on the optical wavelength.

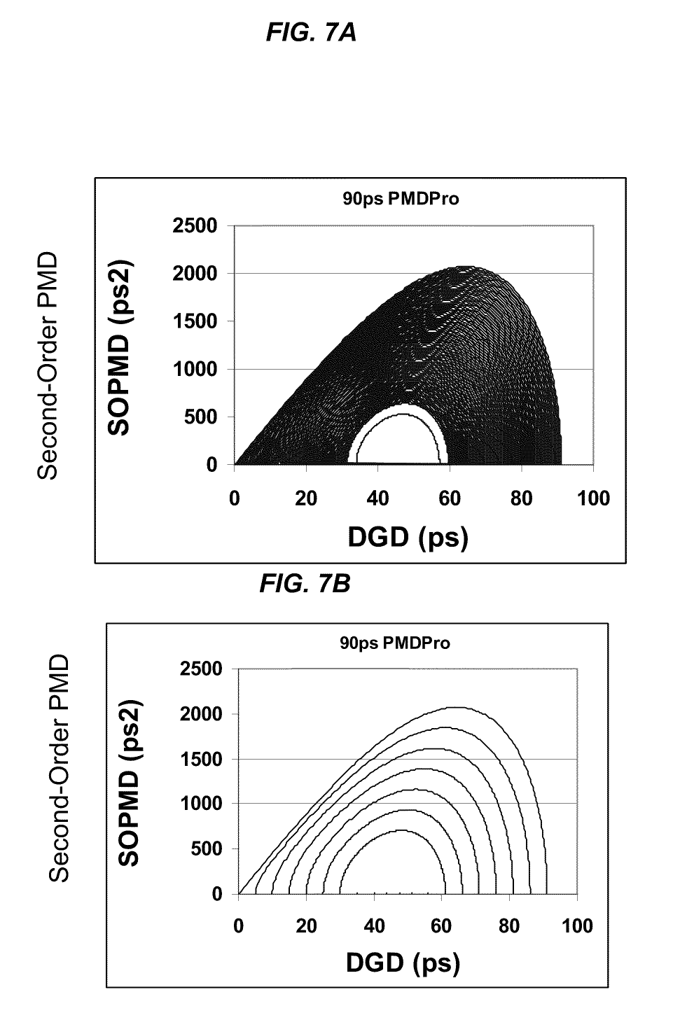

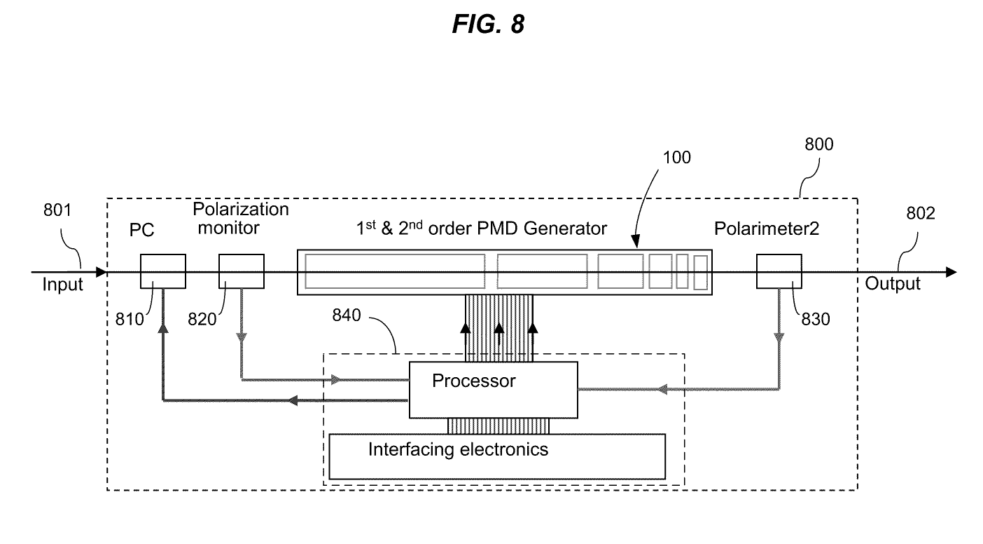

Notably, it is discovered that the implementation of the device in FIG. 5 by using one continuously tunable polarization rotator at the input while using all two-state polarization rotators for the rest of the device can render all PMD states generated by the device in FIG. 5 to be independent of the optical wavelength of light. FIGS. 7A and 7B show the SOPMD-DGD mapping in this device. FIG. 7A shows the SOPMD values as a function of the DGD values between 0 to 100 ps. In comparison with the PMD-DGD map in FIG. 6 for the PMD states generated by the device in FIG. 1 with all three-state polarization rotators, this combination of using one continuously tunable polarization rotator at the input while using all two-state polarization rotators for the rest of the device based on the device in FIG. 5 provides quasi continuous PMD states as the continuously tunable polarization rotator is tuned under various combinations of discrete states of the downstream two-state polarization rotators.

In operation, for a given set of settings in the two-state polarization rotators and a given set of fixed DGD values for the DGD segments, continuous tuning of the continuously tunable polarization rotator cause the SOPMD value to change continuously along one of the curves shown in FIG. 7B which shows selected PMD-DGD curves generated by certain combinations of settings in the two-state polarization rotators and a given set of fixed DGD values for the DGD segments. This continuous tunability in the PMD within certain regions of the PMD-DGD map, the quasi continuous PMD-DGD coverage and the wavelength-independent PMD states make this particular implementation of the device in FIG. 5 advantageous in various PMD emulation and compensation applications.

PMD emulators or compensators based on devices in FIGS. 1-5 can be implemented in various optical devices and systems to provide desired PMD emulation or compensation. Specific examples are provided below with specific reference to the device 100 in FIG. 1. It is understood that other devices in FIGS. 2-5 can also be used to implement the described examples.

FIG. 8 shows an example of a polarization optimized PMD source or emulator 800 based on the device 100 in FIGS. 1-5. In the illustrated device 800, an input polarization controller (PC) 810 is provided in the optical path upstream to the DGD segments and the tunable optical polarization rotators in the device 100 in FIG. 1 or a device in FIGS. 2-5 to receive an input beam 801 and to control polarization of the input beam 801. The device processes the input beam 801 to produce an output beam 802. An input polarimeter 820 is provided in the optical path upstream to the DGD segments and the tunable optical polarization rotators and downstream from the input polarization controller 810 to measure input polarization of the light received from the input polarization controller 810. In addition, an output polarimeter 830 is provided in the optical path downstream from the DGD segments and the tunable optical polarization rotators to measure output polarization of the light received from the DGD segments and the tunable optical polarization rotators. The control module 340 represented by “processor” and “interfacing electronics” controls at least one of (1) the input polarization controller and (2) the tunable optical polarization rotators based on the measured input polarization and the measured output polarization of the output beam 802.

In operating the device 800 in FIG. 8, when performing a PMD tolerant test of a communication link or system, it is desirable that the input SOP to the PMD source/emulator is aligned for the maximum PMD effect. The device in FIG. 8 is designed for achieving automatic polarization optimization while generating different PMD values. Specifically, the device in FIG. 8 can generate different PMD values by controlling the tri-state PMD generator 100 with a micro-processor or a computer. All possible PMD values of the PMD generator 100 can be tabulated in a look-up table. Different PMD values are picked from the look-up table according to the user's selection. In another operation, the device in FIG. 8 can be used to generate statistical 1st and 2nd order PMD distributions by programming the processor with different distribution functions, such as Maxwellian distribution. The PMD values are picked from the look-up table according to statistical weights of a particular distribution.

In yet another application, the device in FIG. 8 can be used for polarization optimization for worst DGD effect—45 degree alignment. The device includes a polarization controller (PC) and a polarization monitor at the input side. The polarization monitor can be an in-line polarimeter or a polarization beam splitter with orientation properly aligned with the axis of the birefringent material elements inside the PMD generator. The processor receives the information from the polarization monitor and send instructions to control the PC according to the signal from the polarization monitor. For example, the processor can be programmed to instruct the PC to align the input SOP 45 degrees from the axis of the birefringent material elements for achieving the worst 1st order PMD effect on the signal passing through the device.

Furthermore, the device in FIG. 8 can be used for polarization optimization for the worst total PMD effect. A second polarimeter or other type of monitor can be placed at the output end of the device to detect the degree of polarization (DOP) or other parameters indicating the PMD effect of the signal passing through the device. The processor receives the signal from the second polarization monitor and instructs the PC to adjust the input SOP according to the value of degree of polarization (DOP). The processor can also control the PMD generator to generate different PMD values. For example, the processor can be programmed to control the PC to minimize the DOP detected by the second polarization monitor for different PMD values. The processor can also compare the DOP values or other parameters obtained from polarization monitors 1 and 2 to see the effect of PMD.

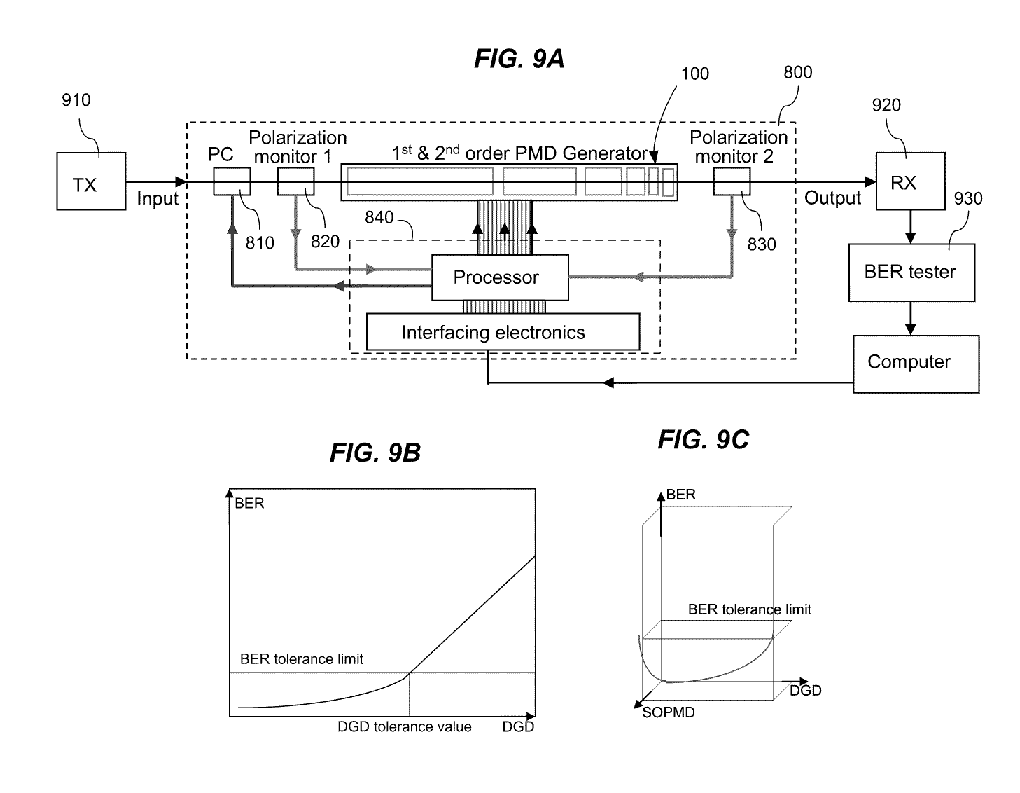

FIG. 9A shows a device for performing PMD tolerance tests that measure the tolerance to PMD of a fiber communication channel. In this example, the device 800 in FIG. 8 is used here to as a PMD source. An optical transmitter TX 910 is provided to generate and direct an input beam into the device 100. An optical receiver RX 920 is placed downstream from the device 100 and the output polarimeter 830. A bit error rate (BER) tester 930 is used to process the electrical output of the optical receiver 920 and to measure the BER. In operation, the device in FIG. 9A is first set for the worst DGD or PMD effect. The data received by the receiver RX 920 is fed into the BER tester 930 to test the bit error rate while the DGD or PMD of the device 100 is gradually increased. The bit error rate (BER) data is plotted vs. the DGD and PMD values, as respectively shown in FIG. 9B and FIG. 9C. The DGD and PMD tolerance is defined as the corresponding DGD or PMD values when the BER is above a threshold set by the user.

The device in FIG. 9A can also be used as a PMD compensator. The device 800 in FIG. 8 is used here for PMD compensation as a part of the receiver module upstream to the receiver detector 920. The input port of the device 800 is connected to receive an input optical signal, e.g., an optical communication signal from a fiber network that is generated by a transmitter 910 coupled to the fiber network. The processor of the device 800 receives the DOP or other PMD indicating parameter from the output polarization monitor 830, and then instructs the PC 810 to adjust the input SOP so that DOP of the signal passing through the device detected by polarization monitor 830 is maximized. The PMD effect is deemed to be compensated when the DOP is maximized for the PMD value setting. To obtain the optimized PMD compensation, the PMD values are also changed while the PC 810 is operated to adjust the input SOP to maximize the DOP. The optimized PMD compensation corresponds to the best PMD settings and the maximum DOP.

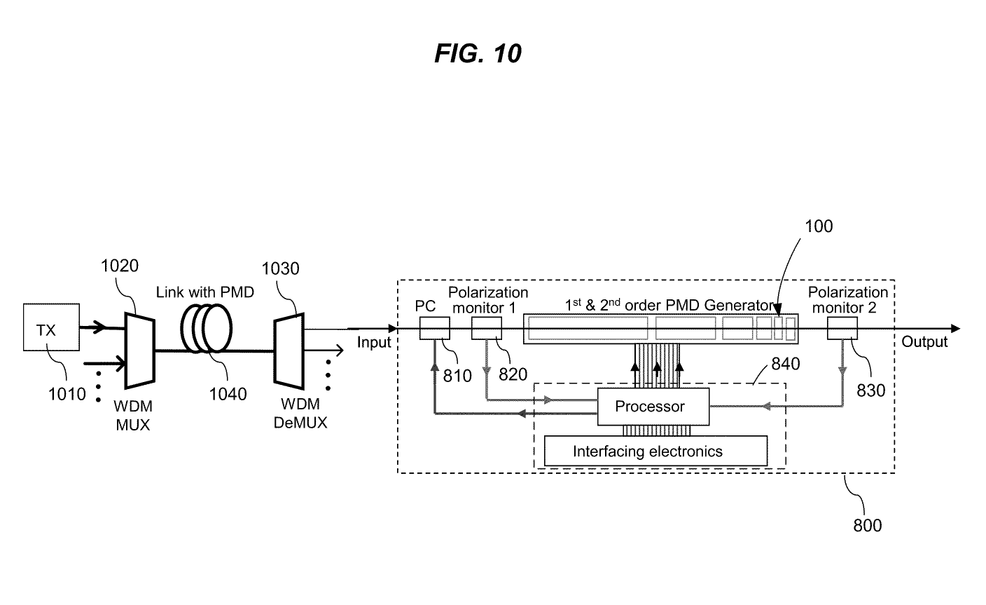

FIG. 10 shows an example of a WDM system that uses the PMD compensator 800 in FIG. 8 based on the device 100 in FIG. 1 or a device in FIGS. 2-5 for link PMD estimation and compensation. In this system, multiple optical transmitters TXs 1010 at the transmitter side of the system are used to produce optical WDM signals at different WDM wavelengths. A WDM multiplexer (MUX) 1020 1010 at the transmitter side of the system is used to combine the optical WDM signals into a fiber link 1040 with PMD for transmission to a receiver at the receiver side of the system. At the receiver side, a WDM demultiplexer (DeMUX) 1030 is used to separate the received optical WDM signals at different WDM wavelengths into individual optical WDM signals along different optical paths. In each optical path, the device 800 in FIG. 8 is provided to process the respective optical WDM signal for PMD compensation and then the processed optical WDM signal is directed downstream for data detection or other processing.

In the PMD compensation mode of the device 800 in FIG. 8, when the PMD compensation is optimized, the corresponding 1st and 2nd order PMD values can be considered to be close to those of the fiber link 1040. Specifically, the processor changes the PMD values while controls the polarization controller (PC) 810 to adjust the input SOP to maximize the DOP value or an other PMD effect indicating parameter detected by the polarization monitor 830. The results of the 1st and 2nd PMD values corresponding to the maximum DOP value generated by the PMD generator is considered to be close to the real PMD values of the fiber link 1040.

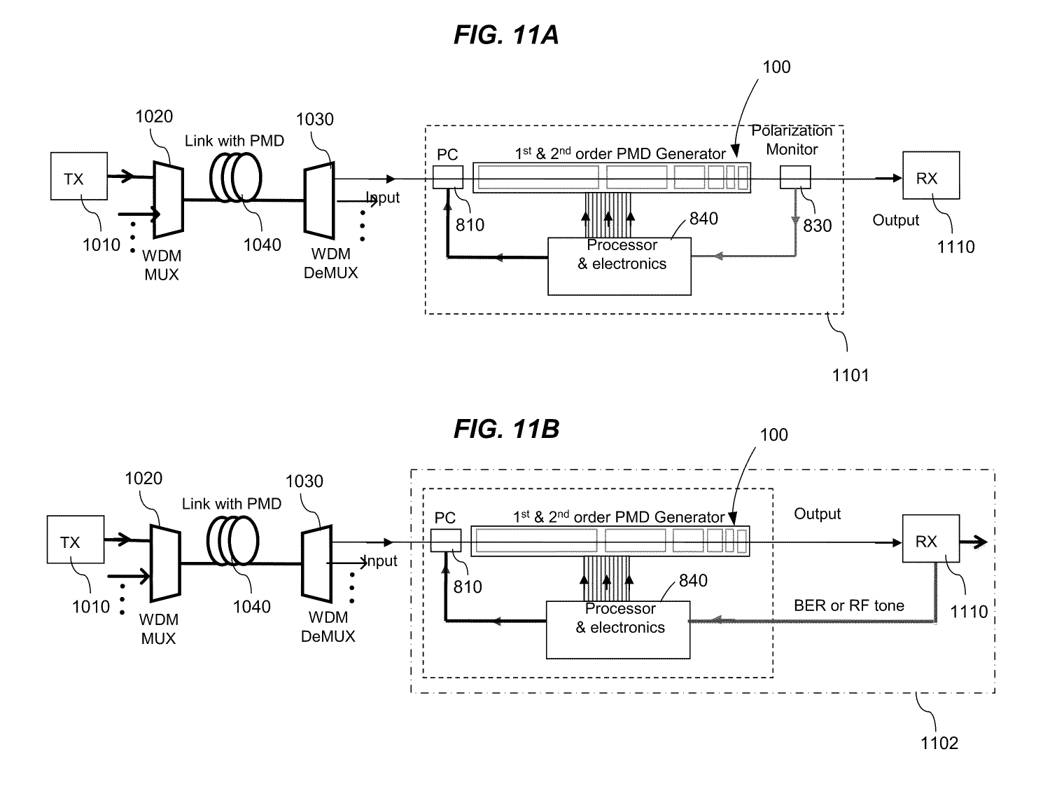

FIGS. 11A and 11B show two optical WDM communication systems that provide PMD compensation in feedback loops based on the device 100 in FIG. 1 or a device in FIGS. 2-5. A PMD compensator 1101 is provided based on the device 100 in FIG. 1 or a device in FIGS. 2-5. As illustrated in FIG. 11A, a polarization controller (PC) 810 is placed upstream from the device 100 to control the optical polarization of the received signal by the device 100 and a polarization monitor 830, such as polarimeter, is coupled to the optical output of the device 100 to detect the combined PMD effect of the link and the PMD source. The PMD effect indicating parameter, such as DOP, is fed back to the microprocessor-based electronic circuit 840. The circuit 840 instructs the polarization controller (PC) 810 to adjust the SOP of the light entering the device 100 to maximize or minimize the parameter. If DOP is used as the parameter, its value will reach a maximum when the PMD is properly compensated. A receiver RX 1110 is provided to receive and detect the optical output of the polarization monitor 830.

FIG. 11B shows an example of PMD compensation using the detected bit-error-rate as the feedback for controlling the device 100 in FIG. 1 or a device in FIGS. 2-5. In this scheme, the PMD compensator 1102 includes the PC 810 the device 100, the receiver RX 1110, the processor based control circuit 840 and the feedback from the receiver RX 1110 to the control circuit 840. The photodetector in the receiver RX 1110 converts the optical signal into an electrical detector signal. This detector signal is directed to a bit-error rate (BER) detection circuit or chip before the error correction circuit. The BER information is then fed into the microprocessor based electronic circuit 840 to instruct the PC 310 to adjust the input SOP to minimize the BER. PMD is effectively compensated when the BER is minimized.

In FIG. 11B, the PMD compensation can be implemented by using RF tones carried by the received optical WDM signals as the feedback for PMD compensation. In this scheme, optical transmitters RXs 1010 on the transmitter side of the system superimpose RF tones on the optical WDM signals. The photodetector in the receiver RX 1010 converts the optical signal into electrical signal and its spectra at certain frequencies are analyzed. The RF powers at these frequencies are indicative of the combined PMD effect of the fiber link and the PMD source. The measured RF powers are then fed back to the microprocessor based electronic circuit 840 so that the circuit 840 can instruct the PC 810 to adjust the input SOP to either minimize or maximize the power of the RF tones.

The above techniques can be used to construct a polarization optimized PMD source with digital tri-state polarization rotators or other designs based on discrete-state polarization rotators described above and to achieve, in various implementations, one or more features for PMD related tests and measurements. For example, high precision and high repeatability PMD generation can be obtained from the highly repeatable rotation angle of each tri-state rotators. For example, such as device can generate totally 729 different PMD states, of which 64 of them are DGD, 192 are wavelength independent 2nd order PMD (SOPMD), and the rest are wavelength dependent PMD. Any one of the PMD states can be selected with high repeatability, or scan sequentially any subset of the PMD states with user defined time intervals. Such a device can be used to generate a desired PMD at a high speed, e.g., around 1 ms or less due to the high speed operations of the tri-state polarization rotators. The high speed operation can speed up PMD tolerance tests and can be used to test the response time of a PMD compensator against sudden PMD changes. For another example, such a device can also be used to automatically optimize the input polarization for the worst-case 1st order and 2nd order PMD tolerance test, regardless of rapid input polarization changes. The polarization optimization can eliminate test uncertainties and can significantly reduce the time required to complete tests. Such features are beneficial to PMD tolerance tests for transceiver production lines of system vendors. For another example, such a device can be used to provide PMD compensation with either optimized PMD value or user selected PMD value. The PMD compensation is accomplished by maximizing DOP detected by the polarimeter at the output port. Both PMD and DOP values will be shown on the front panel LCD display. By stepping PMD values up and down and looking at the maximized DOP values, the user can directly see how the PMD value chosen affects PMD compensation. When selecting optimized PMD mode, the instrument will go through all PMD states and search for the maximum DOP. The PMD state with maximum DOP is selected as the optimized PMD for PMD compensation.

Referring to FIGS. 10, 11A and 11B, such a device can be used to determine PMD value of an in-service fiber link because the optimized PMD value for the PMD compensation is close to the PMD value of the fiber link. Therefore, in order to determine the PMD value of a fiber link, a polarization optimized PMD source can be used to enable the PMD compensation function. The optimized PMD shown on the LCD display is then the PMD value of the link. The PMD condition of a particular channel route in an in-service ROADM network can be measured before installation of 40 G transmitters and receivers to determine its feasibility for the 40 G operation. In such a situation, an ASE source, a light source that emits light with a broad spectral range (e.g., white light) based on the amplified spontaneous emission (ASE), may be used at the transmitter end and a polarization optimized PMD source can be used at the receiver end to perform PMD compensation. The optimized PMD value is thus the PMD value of the fiber route. Based on this PMD information, it can be decided whether the route is suitable for 40 G transmission and whether a PMD compensator is required. In implementations, an optical amplifier, such as an Er-doped fiber amplifier (EDFA), may be used before the PMD source to boost the signal level.

For another example, the disclosed PMD devices based on the designs in FIGS. 1-5 can be used for system impairment diagnosis. In a fiber link with performance problems, it can be difficult to determine the cause of the problem, whether it is a PMD issue, a chromatic-dispersion issue (CD), a signal-to-noise (SNR) issue, or some other issues. Performing PMD compensation can be used to determine whether the problem is caused by PMD or not. In this regard, if PMD compensation solves the transmission problem, this indicates that PMD is the cause. Otherwise, PMD may not be an issue. With such a diagnosis, it can be determined whether PMD compensation is required for the fiber link.

Another application of the present PMD source is PMD emulation. Programming the PMD generator can generate statistical PMD distribution to emulate PMD variations in fiber systems.

In addition, polarization control functions can be provided in some implementations. The build-in polarization controller and polarimeters can be controlled to program the instrument for various polarization control functions, including deterministic SOP generation, polarization scrambling, and polarization trace generation. Therefore, the instrument can be used as a general purpose polarization synthesizer/controller for all polarization control needs.

Polarization optimizations can be performed by using the PMD source in this document. For example, in a DGD tolerance test, the input SOP can be optimized by using SOP detected by the first polarimeter as feedback for the worst signal degradation caused by DGD. For another example, in a PMD tolerance test, the input SOP can be optimized by minimizing DOP detected by the second polarimeter as feedback for the worst signal degradation caused by both DGD and SOPMD. For yet another example, in PMD compensation, the input SOP can be optimized by maximizing DOP detected by the second polarimeter for the least signal degradation caused by DGD and SOPMD.

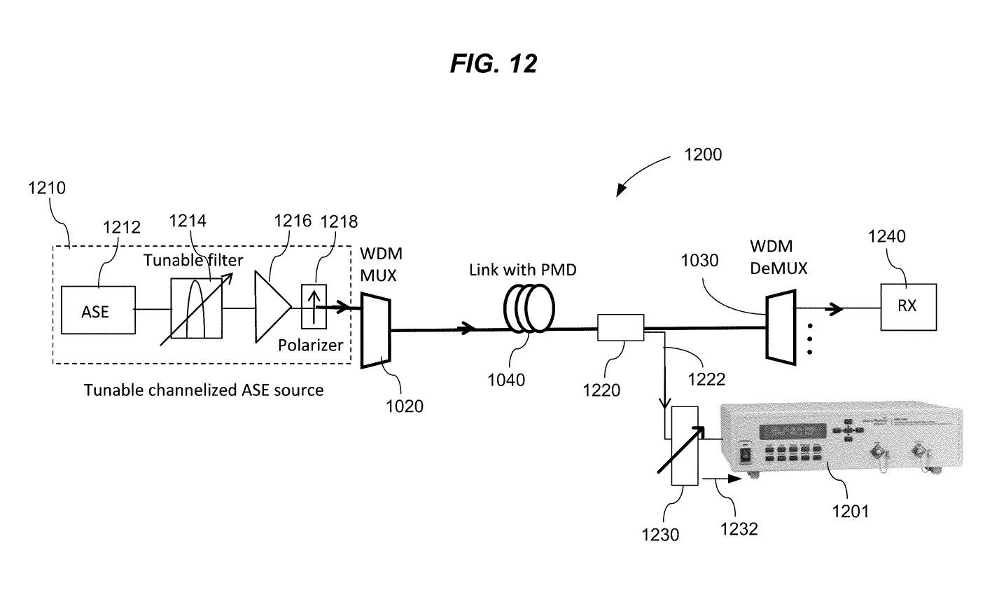

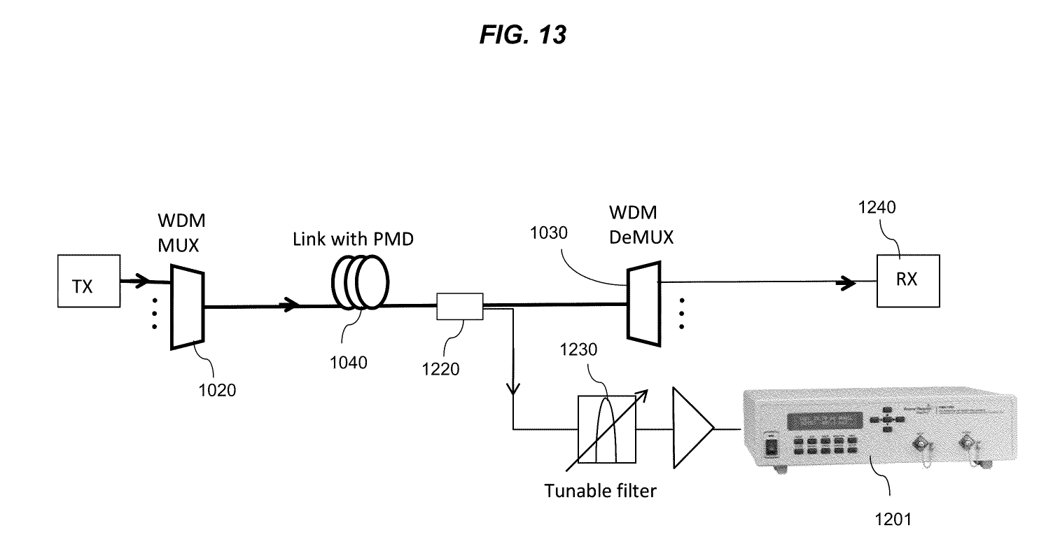

FIGS. 12 and 13 show two exemplary optical communication systems equipped with PMD monitoring and PMD compensation described above.

FIG. 12 shows a fiber communication system 1200 that provides a tunable channelized ASE source 1210 at the signal transmitter to allow for measuring the PMD at different WDM channel wavelengths. The tunable channelized ASE source 1210 can produce an optical test signal at any one of the WDM channel wavelengths with a linear polarization. This optical test signal is directed through the signal transmission path of the an optical WDM signal, including the WDM multiplexer 1020 and the fiber link 1040 with PMD, to the receiver side of the fiber system 1200. As such, the PMD in this optical test signal can reflect the actual PMD of the system. The tunable channelized ASE source 1210 includes an ASE light source 1212, and a tunable optical filter 1214 that filters the light from the light source 1212 to transmit light at any one of WDM wavelengths, e.g., ITU WDM wavelengths specified by International Telecommunications Union (ITU) with a bandwidth based on the ITU specification (e.g., 0.2 nm to 0.3 nm). An optical amplifier 1216 may be used to amplify the transmission light from the tunable optical filter 1214. An optical polarizer 1218 can be used to ensure the proper linear polarization of the optical test signal directed to the WDM multiplexer 1020.

An optical coupler 1220 is provided at the receiver side of the system and is located upstream to the WDM demultiplexer 1030 to split a portion of the light received by the WDM demultiplexer 1030 off as an optical monitor signal 1222 which contains the light of the optical test signal. A tunable optical filter 1230 is coupled to receive the optical monitor signal 1222 and to produce a filtered optical monitor signal 1232. The tunable optical filter 1230 is tuned to the same WDM wavelength of the tunable optical filter 1214. The filtered optical monitor signal 1232 is then directed into a PMD instrument 1201 based on one of the devices in FIGS. 1-5, such as the PMD devices 800, 1101 and 1102 in FIGS. 10, 11A and 11B. In operation, the tunable filters 1214 and 1230 can be tuned to any one of the WDM channel wavelengths to measure the PMD properties of the respective WDM channel so that the PMD properties of multiple WDM channels can be measured at different times.

FIG. 13 shows a fiber communication system 1300 that provides a tunable optical filter at the receiver side to allow for selecting any one of the different WDM channel wavelengths to produce an optical monitor signal for the selected WDM channel. At the receiver side of this system, the optical coupler 1220 is similarly is located upstream to the WDM demultiplexer 1030 to split a portion of the light received by the WDM demultiplexer 1030 off as an optical monitor signal 1222 which contains the light of all WDM channels. The tunable optical filter 1230 is used to filter the optical monitor signal 1222 to produce a filtered optical monitor signal that contains light of a selected WDM channel. Tuning of the tunable optical filter 1230 allows the PMD properties of multiple WDM channels to be measured at different times. Under this design, the actual WDM channel signals are used for the PMD measurements and the tunable channelized ASE source 1210 in FIG. 12 is eliminated.

The system designs used in FIGS. 12 and 13 use a single PMD instrument 1201 connected at a designated optical monitoring signal path to monitor PMD of all channels by using a tunable optical filter 1230 for selecting a respective WDM channel at a time. These designs are based on sharing of the same PMD instrument 1201 for PMD monitoring at all WDM channels and thus eliminate the need for connecting the PMD instrument 1201 to each of the multiple optical WDM paths downstream from the WDM DeMUX 1030.

While this document contains many specifics, these should not be construed as limitations on the scope of an invention or of what may be claimed, but rather as descriptions of features specific to particular embodiments of the invention. Certain features that are described in this document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or a variation of a subcombination.

Only a few examples and implementations are described. However, variations, modifications, and enhancements of the described implementations and other implementations can be made based on what is described and illustrated in this document.

What is claimed is:

1. An optical device, comprising:
a plurality of differential group delay (DGD) segments each exhibiting optical birefringence to effectuate a DGD between light of two orthogonal polarizations that transmits through each DGD segment, the DGG segments arranged along an optical path and separated from each other along the optical path;
a plurality of tunable optical polarization rotators respectively located in gaps between the DGD segments, one tunable optical polarization rotator per gap to rotate polarization of light after exiting one DGD segment and before entering a downstream DGD segment, each tunable optical polarization rotator responsive to a control signal to produce three different polarization rotations; and
a control module in communication with the tunable optical polarization rotators to individually control each of the optical polarization rotators to produce one of the three different polarization rotations to produce polarization mode dispersion of a first order and one or more higher orders on the light that transmits through the DGD segments and the tunable optical polarization rotators.

2. The device as in claim 1, wherein:
each tunable optical polarization rotator comprises:
two two-state polarization rotators placed in series along the optical path, each two-state rotator adjustable to change a rotation of polarization of light transmitting therethrough between a first rotation angle and a second equal rotation angle in an opposite direction of the first rotation angle, and
the control module controls the two-two polarization rotators to produce the three different polarization rotations collectively produced by the two two-state polarization rotators.

3. The device as in claim 2, wherein:
each two-state polarization rotator is a magneto-optic (MO) polarization rotator.

4. The device as in claim 2, wherein:
in each two-state polarization rotator, the first rotation angle is +22.5°, and the second opposite rotation angle is −22.5°.

5. The device as in claim 2, wherein:
the control module operates the two two-state polarization rotators in each optical polarization rotator to (1) both rotate polarization by the first rotation angle, (2) rotate polarization by the first rotation angle and the second opposite rotation angle, respectively, and (3) both rotate polarization by the second opposite rotation angle.

6. The device as in claim 1, wherein:
the DGD segments have different lengths to produce different DGD values, respectively.

7. The device as in claim 6, wherein:
lengths of the DGD segments differ by a factor of 2 or 2^{m}, where m is an integer.

8. The device as in claim 6, wherein:
each of the DGD segments is a tunable DGD segment that responds to a control signal to vary a DGD value, and
the control module is in communication with the DGD segments to individually control DGD values of the DGD segments.

9. The device as in claim 1, comprising:
an input polarization controller in the optical path upstream to the DGD segments and the tunable optical polarization rotators to receive an input beam and to control polarization of the input beam;
an input polarimeter in the optical path upstream to the DGD segments and the tunable optical polarization rotators and downstream from the input polarization controller to measure input polarization of the light received from the input polarization controller; and
an output polarimeter in the optical path downstream from the DGD segments and the tunable optical polarization rotators to measure output polarization of the light received from the DGD segments and the tunable optical polarization rotators,
wherein the control module controls at least one of (1) the input polarization controller and (2) the tunable optical polarization rotators based on the measured input polarization and the measured output polarization.

10. The device as in claim 9, wherein:
each of the DGD segments is a tunable DGD segment that responds to a control signal to vary a DGD value, and
the control module is in communication with the DGD segments to individually control DGD values of the DGD segments.

11. The device as in claim 10, wherein:
the control module controls, at least, both the DGD segments and the optical polarization rotators based on the measured input polarization and the measured output polarization.

12. The device as in claim 1, comprising:
an input polarization controller in the optical path upstream to the DGD segments and the tunable optical polarization rotators to receive an input beam and to control polarization of the input beam; and
an output polarimeter in the optical path downstream from the DGD segments and the tunable optical polarization rotators to measure output polarization of the light received from the DGD segments and the tunable optical polarization rotators,
wherein the control module controls at least one of (1) the input polarization controller and (2) the tunable optical polarization rotators based on the measured input polarization and the measured output polarization.

13. The device as in claim 1, comprising:
an input polarization controller in the optical path upstream to the DGD segments and the tunable optical polarization rotators to receive an input beam and to control polarization of the input beam; and
an optical detector that detects output light from the DGD segments and the tunable optical polarization rotators;
a bit error rate monitor device that measures a bit error rate of a detector output from the optical detector; and
a feedback control unit that feeds a feedback signal based on the measured bit error rate in the detector output to the control module, wherein the control module responds to the feedback signal to adjust at least one of (1) the input polarization controller and (2) the optical polarization rotators to reduce a bit error rate in the detector output.

14. The device as in claim 1, comprising:
an input polarization controller in the optical path upstream to the DGD segments and the tunable optical polarization rotators to receive an input beam and to control polarization of the input beam; and
an optical detector that detects output light from the DGD segments and the tunable optical polarization rotators;
a feedback control that processes a detector output from the optical detector to extract spectral information of RF tones carried by the input beam and controls the control module to control at least one of the (1) input polarization controller and (2) the optical polarization rotators to either maximize or minimize power of the extracted RF tones to reduce a bit error rate in the output light.

15. A communication device for optical wavelength division multiplexing (WDM), comprising:
a WDM demultiplexer that separates optical WDM signals at different WDM wavelengths along different signal paths; and
a plurality of optical receivers located in the different signal paths, respectively, each optical receiver receiving one optical WDM signal at a respective WDM wavelength to extract data carried by the received optical WDM signal,
wherein each optical receiver includes a polarization mode dispersion (PMD) compensator that includes:
a plurality of differential group delay (DGD) segments each exhibiting optical birefringence to effectuate a DGD between light of two orthogonal polarizations that transmits through each DGD segment, the DGG segments arranged along an optical path and separated from each other along the optical path;
a plurality of tunable optical polarization rotators respectively located in gaps between the DGD segments, one tunable optical polarization rotator per gap to rotate polarization of light after exiting one DGD segment and before entering a downstream DGD segment, each tunable optical polarization rotator responsive to a control signal to produce three different polarization rotations; and
a control module in communication with the tunable optical polarization rotators to individually control each of the optical polarization rotators to produce one of the three different polarization rotations to produce polarization mode dispersion of a first order and one or more higher orders on the light that transmits through the DGD segments and the tunable optical polarization rotators to negate PMD in the received optical WDM signal.

16. The device as in claim 15, wherein:
each tunable optical polarization rotator comprises:
two two-state polarization rotators placed in series along the optical path, each two-state rotator adjustable to change a rotation of polarization of light transmitting therethrough between a first rotation angle and a second equal rotation angle in an opposite direction of the first rotation angle, and
the control module controls the two-two polarization rotators to produce the three different polarization rotations collectively produced by the two two-state polarization rotators.

17. The device as in claim 16, wherein:
each two-state polarization rotator is a magneto-optic (MO) polarization rotator.

18. The device as in claim 16, wherein:
in each two-state polarization rotator, the first rotation angle is +22.5°, and the second opposite rotation angle is −22.5°.

19. The device as in claim 16, wherein:
the control module operates the two two-state polarization rotator in each optical polarization rotator to (1) both rotate polarization by the first rotation angle, (2) rotate polarization by the first rotation angle and the second opposite rotation angle, respectively, and (3) both rotate polarization by the second opposite rotation angle.

20. The device as in claim 15, wherein:
the DGD segments have different lengths to produce different DGD values, respectively.

21. The device as in claim 20, wherein:
lengths of the DGD segments differ by a factor of 2 or 2^{m}, where m is an integer.

22. The device as in claim 20, wherein:
each of the DGD segments is a tunable DGD segment that responds to a control signal to vary a DGD value, and
the control module is in communication with the DGD segments to individually control DGD values of the DGD segments.

23. The device as in claim 15, wherein:
each optical receiver comprises:
an input polarization controller in the optical path upstream to the DGD segments and the tunable optical polarization rotators to receive an input beam and to control polarization of the input beam;
an input polarimeter in the optical path upstream to the DGD segments and the tunable optical polarization rotators and downstream from the input polarization controller to measure input polarization of the light received from the input polarization controller; and
an output polarimeter in the optical path downstream from the DGD segments and the tunable optical polarization rotators to measure output polarization of the light received from the DGD segments and the tunable optical polarization rotators,
wherein the control module controls at least one of (1) the input polarization controller and (2) the tunable optical polarization rotators based on the measured input polarization and the measured output polarization.

24. The device as in claim 23, wherein:
each optical receiver comprises:
an optical detector that detects output light from the output polarimeter;
a bit error rate monitor device that measures a bit error rate of a detector output from the optical detector; and
a feedback control unit that feeds a feedback signal based on the measured bit error rate in the detector output to the control module, wherein the control module responds to the feedback signal to adjust at least one of the (1) the input polarization controller and (2) the optical polarization rotators to reduce a bit error rate in the output light.

25. The device as in claim 24, wherein:
each of the DGD segments is a tunable DGD segment that responds to a control signal to vary a DGD value, and
the control module is in communication with the DGD segments to individually control DGD values of the DGD segments, in addition to controlling one of (1) the input polarization controller and (2) the optical polarization rotators, in response to the feedback control signal.

26. The device as in claim 23, wherein:
each of the DGD segments is a tunable DGD segment that responds to a control signal to vary a DGD value, and
the control module is in communication with the DGD segments to individually control DGD values of the DGD segments.

27. The device as in claim 26, wherein:
the control module controls, at least, both the DGD segments and the optical polarization rotators based on the measured input polarization and the measured output polarization.

28. The device as in claim 16, wherein:
each optical receiver comprises:
an input polarization controller in the optical path upstream to the DGD segments and the tunable optical polarization rotators to receive an input beam and to control polarization of the input beam; and
an output polarimeter in the optical path downstream from the DGD segments and the tunable optical polarization rotators to measure output polarization of the light received from the DGD segments and the tunable optical polarization rotators,
wherein the control module controls at least one of (1) the input polarization controller and (2) the tunable optical polarization rotators based on the measured input polarization and the measured output polarization.

29. The device as in claim 16, wherein:
each optical receiver comprises:
an input polarization controller in the optical path upstream to the DGD segments and the tunable optical polarization rotators to receive an input beam and to control polarization of the input beam; and
an optical detector that detects output light from the DGD segments and the tunable optical polarization rotators;
a bit error rate monitor device that measures a bit error rate of a detector output from the optical detector; and
a feedback control unit that feeds a feedback signal based on the measured bit error rate in the detector output to the control module, wherein the control module responds to the feedback signal to adjust at least one of (1) the input polarization controller and (2) the optical polarization rotators to reduce a bit error rate in the detector output.

30. The device as in claim 16, wherein:
each optical receiver comprises:
an input polarization controller in the optical path upstream to the DGD segments and the tunable optical polarization rotators to receive an input beam and to control polarization of the input beam; and
an optical detector that detects output light from the DGD segments and the tunable optical polarization rotators;
a feedback control that processes a detector output from the optical detector to extract spectral information of RF tones carried by the input beam and controls the control module to control at least one of the (1) input polarization controller and (2) the optical polarization rotators to either maximize or minimize power of the extracted RF tones to reduce a bit error rate in the output light.

31. An optical device, comprising:
an input port to receive input light;
a plurality of differential group delay (DGD) segments each exhibiting optical birefringence to effectuate a DGD between light of two orthogonal polarizations pass through the DGD segment, the DGG segments arranged separated from one another along an optical path that receives the input light from the input port;
a plurality of tunable optical polarization rotators respectively located in gaps between the DGD segments, each tunable optical polarization rotator operable rotates polarization of light after exiting one DGD segment and before entering a downstream DGD segment, the tunable optical polarization rotators including at least one continuously tunable optical rotator responsive to a continuous tuning control signal to continuously rotate polarization of light to reach a desired rotation of the polarization of light, and discrete-state tunable optical polarization rotators responsive to respective discrete-state control signals to produce two or more different discrete polarization rotations; and
a control module in communication with the tunable optical polarization rotators to individually control each of the optical polarization rotators, the control module operable to produce varying values of the continuous tuning control signal in operating the continuously tunable optical rotator, and to produce one of discrete values of each discrete-state control signal to operate each respective discrete-state tunable optical polarization rotator to produce a respective one of the two or more discrete polarization rotations.

32. The device as in claim 31, wherein:
the discrete-state tunable optical polarization rotators are tunable two-state polarization rotators each adjustable to change a rotation of polarization of light transmitting therethrough between a first rotation angle and a second equal rotation angle in an opposite direction of the first rotation angle.

33. The device as in claim 31, wherein:
the discrete-state tunable optical polarization rotators include tunable two-state polarization rotators each adjustable to change a rotation of polarization of light transmitting therethrough between a first rotation angle and a second equal rotation angle in an opposite direction of the first rotation angle.

34. The device as in claim 32, wherein:
in each two-state polarization rotator, the first rotation angle is +22.5°, and the second opposite rotation angle is −22.5°.

35. The device as in claim 31, wherein:
the discrete-state tunable optical polarization rotators include:
tunable three-state polarization rotators each adjustable to change a rotation of polarization of light transmitting therethrough to be at three different discrete rotation angles; and
tunable two-state polarization rotators each adjustable to change a rotation of polarization of light transmitting therethrough between three different discrete rotation angles.

36. The device as in claim 35, wherein:
the discrete-state tunable optical polarization rotators include tunable three-state polarization rotators each adjustable to change a rotation of polarization of light transmitting therethrough to be at three different discrete rotation angles, and
each tunable three-state polarization rotator includes two two-state polarization rotators placed in series along the optical path, each two-state rotator adjustable to change a rotation of polarization of light transmitting therethrough between a first rotation angle and a second equal rotation angle in an opposite direction of the first rotation angle, and
the control module controls the two-two polarization rotators to produce the three different discrete rotation angles collectively produced by the two two-state polarization rotators.

37. The device as in claim 36, wherein:
the control module operates the two two-state polarization rotators of each tunable three-state polarization rotator to (1) both rotate polarization by a first discrete rotation angle, (2) rotate polarization by the first discrete rotation angle and a second discrete rotation angle equal in magnitude and opposite in direction of the first discrete rotation angle, respectively, and (3) both rotate polarization by the second discrete rotation angle.

38. A method for measuring optical polarization mode dispersion (PMD) in a fiber link, comprising:
using a WDM demultiplexer to receive optical wavelength-division-multiplexed (WDM) signals at different WDM wavelengths from a fiber link and to separate the received optical WDM signals along different signal paths;
using an optical receiver located in one of the different signal paths to receive and process a respective optical WDM signal at a respective WDM wavelength to measure PMD of the optical WDM signal by using differential group delay (DGD) segments separated from each other along the optical path and each exhibiting optical birefringence to effectuate a DGD between light of two orthogonal polarizations that transmits through each DGD segment, and by using tunable optical polarization rotators respectively located in gaps between the DGD segments, wherein the tunable optical polarization rotators include discrete-state tunable optical polarization rotators responsive to respective discrete-state control signals to produce two or more different discrete polarization rotations; individually controlling each of the tunable optical polarization rotators to produce polarization mode dispersion of a first order and one or more higher orders on the light that transmits through the DGD segments and the tunable optical polarization rotators to negate PMD in the received optical WDM signal; and
using settings of the tunable optical polarization rotators and DGD values of the DGD segments to measure the PMD in the fiber link.

39. A method for measuring optical polarization mode dispersion (PMD) in a fiber link, comprising:
using a WDM demultiplexer to receive optical wavelength-division-multiplexed (WDM) signals at different WDM wavelengths from a fiber link and to separate the received optical WDM signals along different signal paths;
splitting light received at the WDM demultiplexer at a location upstream from the WDM demultiplexer to produce an optical monitor signal to an optical monitor signal path separate from the different signal paths;
tuning an tunable optical filter in the optical monitor signal path to a selected WDM channel to filter light of the optical monitor signal to transmit light within the selected WDM channel as a filtered optical monitor signal for the selected WDM channel;
using a PMD instrument to process the filtered optical monitor signal for the selected WDM channel to measure PMD of the selected WDM by using differential group delay (DGD) segments separated from each other along the optical path and each exhibiting optical birefringence to effectuate a DGD between light of two orthogonal polarizations that transmits through each DGD segment, and by using tunable optical polarization rotators respectively located in gaps between the DGD segments, wherein the tunable optical polarization rotators include discrete-state tunable optical polarization rotators responsive to respective discrete-state control signals to produce two or more different discrete polarization rotations; and
individually controlling each of the tunable optical polarization rotators to produce polarization mode dispersion of a first order and one or more higher orders on the light that transmits through the DGD segments and the tunable optical polarization rotators to negate PMD in the selected WDM channel; and
using settings of the tunable optical polarization rotators and DGD values of the DGD segments to measure the PMD in the fiber link for the selected WDM channel.

40. The method as in claim 39, comprising:
subsequently tuning the tunable optical filter in the optical monitor signal path to a second selected WDM channel; and
operating the PMD instrument to measure respective PMD of the second selected WDM channel.

41. The method as in claim 39, comprising:
in operating the PMD instrument, monitoring a polarization state of light passing through the tunable optical polarization rotators, and
controlling a polarization of the light entering the PMD instrument based on the monitored polarization state of light passing through the tunable optical polarization rotators in measuring the PMD.

42. The method as in claim 39, comprising:
in operating the PMD instrument, monitoring a bit error rate of light passing through the tunable optical polarization rotators, and
controlling the tunable optical polarization rotators to minimize the bit error rate in measuring the PMD.

43. The method as in claim 39, comprising:
in operating the PMD instrument, monitoring an RF tone carried in the light passing through the tunable optical polarization rotators, and
controlling the tunable optical polarization rotators to minimize or maximize a power of the RF tone in measuring the PMD.

44. The method as in claim 39, comprising:
at a transmitter side of the fiber link, using a light source to produce an optical test signal of a broad spectral band covering the different optical WDM wavelengths and a tunable optical filter to filter the optical test signal to contain light at the selected WDM channel.

45. The method as in claim 44, comprising:
subsequently tuning the tunable optical filter at the transmitter side of the fiber link and the tunable optical filter in the optical monitor signal path to a second selected WDM channel; and
operating the PMD instrument to measure respective PMD of the second selected WDM channel.
